(19) United States
(12) Patent Application Publication
(10) Pub. No.: US 2025/0307814 A1
(43) Pub. Date: Oct. 2, 2025

(54) AMALGAMATED QUICK RESPONSE ("QR")-POWERED, NON-FUNGIBLE TOKEN ("NFT")-SCORING-BASED PROTEGE MONEY TRANSFER TECHNOLOGY

(71) Applicant: Bank of America Corporation, Charlotte, NC (US)

(72) Inventors: Shailendra Singh, Maharashtra (IN); Saurabh Gupta, New Delhi (IN)

(21) Appl. No.: 18/621,239

(22) Filed: Mar. 29, 2024

(51) Int. Cl. G06Q 20/40; G06K 19/06

(52) U.S. Cl. CPC G06Q 20/401; G06K 19/06037; G06Q 2220/00

(57) ABSTRACT

Methods and systems for providing a quick response (“QR”) code having increased security authentication parameters. The methods and systems may include creating a dependent QR code and one or more independent QR codes for approving or rejecting a dependent QR code transaction request in a merged QR code. The methods and systems may include creating one or more trust deficit non-fungible tokens (“NFTs”) for each of one or more users associated with the one or more independent QR codes rejecting the dependent QR code transaction request. The methods and systems may include adding the one or more trust deficit NFTs to the dependent QR code in the merged QR code. The methods and systems may include rejecting the transaction in response to the determination that the dependent QR code has a number of trust deficit NFTs greater than the threshold number.

### FIELD OF TECHNOLOGY

Aspects of the disclosure relate to increasing security using quick response (“QR”)-codes for non-fungible token (“NFT”)-scoring-based money transfer.

### BACKGROUND OF THE DISCLOSURE

In an increasingly digital and cashless world, parents and guardians face challenges in imparting responsible money management skills to their children and dependents. With easy access to debit and credit cards, online payment platforms, and mobile wallets, young individuals often lack the guidance needed to make informed financial decisions. The absence of a structured system for managing allowances and expenditures can lead to overspending, financial mismanagement, and missed opportunities for financial education.

Children and dependents may not have a fundamental understanding of financial concepts like budgeting, saving, and investing. This lack of financial understanding may lead to impulsive spending and an inability to plan.

Without oversight, young individuals may make uninformed or impulsive purchases, which can strain the finances of their parents or guardians and leave them unprepared for emergencies. For example, there is a risk that dependent individuals will overspend.

The proliferation of online payment methods and digital transactions exposes children and dependents to potential risks such as fraud, identity theft, and unauthorized payments. Therefore, there exists a need to address these online security concerns.

Parents and guardians currently lack a convenient and effective means of setting spending limits, monitoring transactions, and providing financial guidance to their children and dependents. Independent individuals supporting dependent individuals have limited control over dependent individuals' financial decisions.

Unfortunately, however, all current mechanisms dealing with such scenarios are reactive approaches—not proactive approaches. An independent user may be informed about a payment or loss of funds based on a dependent user's transaction, after the transaction has already occurred. In such cases, there may be no way to prevent dependent user overspending prior to its occurrence.

It would therefore be desirable to enable an independent user to proactively approve or reject a transaction request from a dependent user associated with a dependent user QR code, prior to completing a transaction.

### SUMMARY OF THE DISCLOSURE

Methods and systems for providing a QR code having increased security authentication parameters are provided. The methods and systems may include creating a dependent QR code and one or more independent QR codes for approving or rejecting a dependent QR code transaction request in a merged QR code.

The methods and systems may include creating one or more trust deficit NFTs for each of one or more users associated with the one or more independent QR codes rejecting the dependent QR code transaction request. The methods and systems may include adding the one or more trust deficit NFTs to the dependent QR code in the merged QR code. The methods and systems may include rejecting the transaction in response to the determination that the dependent QR code has a number of trust deficit NFTs greater than a threshold number.

The methods and systems may include creating one or more trust NFTs for each of one or more users associated with the one or more independent QR codes approving the dependent QR code transaction request. The methods and systems may include adding the one or more trust NFTs to the dependent QR code in the merged QR code. The methods and systems may include approving the transaction in response to the determination that the dependent QR code has a number of trust NFTs greater than a threshold number.

The methods and systems may include overriding and rejecting the transaction in response to the determination that the dependent QR code has a number of trust deficit NFTs greater than the number of trust NFTs. The methods and systems may include overriding and approving the transaction in response to the determination that the dependent QR code has a number of trust NFTs greater than the number of trust deficit NFTs.

The technology provided herein may significantly mitigate attempts to derail and defraud the QR payments industry. This technology may significantly improve the fidelity of the QR payments industry.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system in accordance with principles of the disclosure;

FIG. 2 shows an illustrative system in accordance with principles of the disclosure;

FIG. 3 shows a schematic diagram of a secure QR code generation apparatus in accordance with principles of the disclosure;

FIG. 4 shows a schematic diagram of a QR code with dynamic placeholders in accordance with principles of the disclosure;

FIG. 5 shows a schematic diagram of a QR code validation procedure in accordance with principles of the disclosure; and

FIG. 6 shows an illustrative flow chart diagram in accordance with principles of the disclosure.

### DETAILED DESCRIPTION OF THE DISCLOSURE

Methods and systems are provided for an amalgamated QR-Powered, NFT scoring-based protege money transfer technology. The technology may enable multiple QR codes to merge into one to make a payment.

The methods and systems may include amalgamating two or more QR codes into one to make a final, amalgamated QR code. The methods and systems may include merging a dependent QR code (e.g., associated with a minor or dependent device user), with, for example, a guardians' QR codes, an educational institution's QR code (e.g., school or college), and a financial institution's QR code. While the disclosure herein is directed to QR codes, the scope of the disclosure may cover any machine-readable labels such as, for example, bar codes or other suitable machine-readable labels.

The methods and systems may include, for each transaction attempted by a minor or dependent, obtaining transaction approval from all merged QR codes, and then allowing the transaction. The methods and systems may include, for example, for any child's attempted transaction, the child's parents, school, and financial institution must approve the transaction for the transaction to be allowed.

The methods and systems may include a child scanning a dependent QR code for making a transaction. The methods and systems may include sending the transaction request to the child's parents, school, and financial institution. The methods and systems may include amalgamating the child's QR code with the parents, school, and financial institution QR codes to make one final merged QR code. The methods and systems may include using the final merged QR code to either allow or reject the child's transaction.

The methods and systems may include considering the dependent QR code incomplete until all associated independent QR codes are merged. A financial institution, for example, may only consider a merged QR code as a complete QR code for a dependent transaction.

The methods and systems may include placing an encrypted field placed on the dependent QR code. The methods and systems may include, if, e.g., an independent QR code is not recognized by a financial institution, scanning the encrypted field. The encrypted field scan may inform the financial institution that the dependent QR code is searching for associated independent QR codes. The methods and systems may include a scanning device communicating with a financial institution. The methods and systems may include financial institutions communicating with independent users, e.g., parents and guardians, and education institutions, e.g., schools, via QR codes.

The methods and systems may include, if a dependent decides to transact without the consent of users of all merged QR codes, placing a trust deficit NFT on the dependent QR code for each transaction attempt. The methods and systems may include, once the dependent QR reaches a threshold number, e.g., five trust deficit NFTs, disabling the dependent QR code from present and future transactions.

The methods and systems may include basing the dependent QR code on the identity of the requestor, e.g., a child or minor. An independent QR code may be associated with a dependent QR code. An independent QR code may be an authenticator of a dependent QR code. Further, an independent QR code may be an authenticator of its own QR code. And transaction approval may be requested by any suitable means, including, e.g., a text message, a phone call, an email, and a QR code.

The methods and systems may include rejecting a transaction, if a dependent QR code holds a threshold number or greater trust deficit NFTs. The threshold number of trust deficit NFTs may be, for example, two, three, four, or five trust deficit NFTs. A transaction may be rejected if a dependent QR code holds even a single trust deficit NFT.

The methods and systems may include a QR Integration Module. The QR Integration Module may integrate a QR code with a user device. The user device may be associated with the QR code. The QR Integration Module may integrate a QR code with a POS device. The POS device may be associated with the QR code.

The methods and systems may include a QR Analyzer. The QR Analyzer may analyze the QR code. The QR Analyzer may determine whether the QR code is a dependent QR code or an independent QR code.

The methods and systems may include a Partners Identifier. The Partners Identifier may identify independent “partner” QR codes associated with a dependent QR code. The Partners Identifier may identify independent device users associated with the independent “partner” QR codes.

The methods and systems may include an Institution Integration Module. The Institution Integration Module may integrate the dependent QR code with a financial institution. The Institution Integration Module may recognize a financial institution QR code associated with the financial institution.

The methods and systems may include a Parent QR Fetcher. The Parent QR Fetcher may obtain QR codes associated with parents or guardians of the dependent device user. The Parent QR Fetcher may identify the independent QR codes associated with parents or guardians of the dependent device user.

The methods and systems may include a Dependent QR Encryption Field Reader. The Dependent QR Encryption Field Reader may read an encrypted algorithm within the dependent QR code. The Dependent QR Encryption Field Reader may encrypt and decrypt algorithms within the dependent QR code.

The methods and systems may include a Fraud Detection Controller. The Fraud Detection Controller may detect fraudulent activity associated with the dependent QR code. The Fraud Detection Controller may control the ability to disable the dependent QR code based on fraudulent activity detected.

The methods and systems may include a Grooming Organization QR Fetcher. The Grooming Organization QR Fetcher may obtain QR codes associated with grooming organizations, e.g., educational institutions, schools, and colleges, of the dependent device user. The Grooming Organization QR Fetcher may identify the independent QR codes associated with grooming (i.e., educational) organizations of the dependent device user.

The methods and systems may include a Payment Approval Interface. The Payment Approval Interface may interface transactions between the dependent QR code and a POS device. The Payment Approval Interface may approve or reject transactions for the dependent QR code at a POS device.

The methods and systems may include an NFT Placement Interface. The NFT Placement Interface may determine what locations on the dependent QR code within the merged QR code to place trust deficit and trust NFTs.

The methods and systems may include a Final Merged QR Preparator. The Final Merged QR Preparator may merge a dependent QR code with one or more independent QR codes to create a final merged QR code. The final merged QR code may allow or reject dependent QR code transactions depending on trust deficit and trust NFTs placed within the dependent QR code.

A method for providing a QR code having increased security authentication parameters is provided. The method may include receiving a request to generate a dependent QR code for requesting a transaction.

The method may include creating a dependent QR code. The dependent QR code may include an encrypted algorithmic code. The dependent QR code may include a request for the transaction. The dependent QR code may include one or more independent QR codes. The dependent QR code may be unable to be used to execute the transaction without obtaining approval from the one or more independent QR codes associated with the dependent QR code.

The method may include scanning the dependent QR code. The method may include decrypting the encrypted algorithmic code to identify the dependent QR code. The method may include decrypting the encrypted algorithmic code to identify the one or more independent QR codes.

The method may include requesting approval for the transaction from one or more users. The one or more users may be associated with the one or more independent QR codes. Each of the one or more users may either approve or reject the transaction.

The method may include creating one or more trust deficit non-fungible tokens (“NFTs”) for each of the one or more independent QR codes associated with users that reject the transaction. The method may include amalgamating the dependent QR code and the one or more independent QR codes to form a merged QR code.

The merged QR code may include the dependent QR code. The merged QR code may include the one or more independent QR codes. The merged QR code may include the one or more trust deficit NFTs.

The method may include determining that the dependent QR code has a number of trust deficit NFTs that is greater than a threshold number. The method may include rejecting the transaction in response to the determination that the dependent QR code has a number of trust deficit NFTs greater than the threshold number.

The method may include generating an additional trust deficit NFT based on one or more previous transactions of a user associated with the dependent QR code. The method may include placing one or more additional trust deficit NFTs within the merged QR code. The method may include determining a location of the dependent QR code within the merged QR code based on the decrypted algorithmic code.

The method may include using the decrypted algorithmic code to determine a placement of the one or more trust deficit NFTs within the merged QR code. The method may include, if the number of trust deficit NFTs is less than the threshold number, placing the trust deficit NFTs within the merged QR code such that it allows a scan of the dependent QR code to be processed at a QR code scanning device. The method may include, if the number of trust deficit NFTs is greater than the threshold number, placing the trust deficit NFTs within the merged QR code such that it prevents a scan of the dependent QR code from being processed at a QR code scanning device.

The method may include accepting the transaction in response to a determination that the dependent QR code has lower than a threshold number of trust deficit NFTs. The method may include allowing a scan of the dependent QR code to be processed at a QR code scanning device when the number of trust deficit NFTs is four or less, wherein the threshold number is five.

The method may include creating one or more trust NFTs for each of the one or more independent QR codes associated with one or more users approving the transaction. The method may include adding the one or more trust NFTs to the merged QR code. The method may include determining that the dependent QR code within the merged QR code holds at least a threshold number of trust NFTs. The method may include overriding the determination that the dependent QR code has a number of trust deficit NFTs that is greater than the threshold number of trust deficit NFTs. The method may include approving the transaction in response to a determination that the dependent QR code within the merged QR code has at least a threshold number of trust NFTs.

The method may include creating one or more trust NFTs for each of the one or more independent QR codes associated with one or more users approving the transaction. The method may include adding the one or more trust NFTs to the merged QR code. The method may include determining that the dependent QR code within the merged QR code holds more trust deficit NFTs than trust NFTs. The method may include rejecting the transaction in response to a determination that the dependent QR code within the merged QR code holds more trust deficit NFTs than trust NFTs.

A system for providing a QR code having increased security authentication parameters is provided. The system may include a dependent user device. The system may include one or more independent user devices. The system may include a point of sale (“POS”) device.

The dependent user device may receive a request to generate a dependent QR code for requesting a transaction. The dependent user device may create a dependent QR code. The dependent QR code may include an encrypted algorithmic code. The dependent QR code may include a request for the transaction.

The one or more independent user devices may receive the request for the transaction. The one or more independent user devices may create one or more independent QR codes. The dependent QR code may be unable to transact without obtaining approval from one or more users associated with the one or more independent QR codes associated with the dependent QR code.

The POS device may scan the dependent QR code. The POS device may decrypt the encrypted algorithm code to identify the dependent QR code. The POS device may decrypt the encrypted algorithm code to identify the one or more independent QR codes.

The POS device may request approval for the transaction from the one or more users associated with the one or more independent QR codes. Each of the one or more users associated with the one or more independent QR codes may either approve or reject the transaction.

The POS device may create one or more trust deficit NFTs for each of the one or more independent QR codes associated with one or more users rejecting the transaction. The POS device may amalgamate the dependent QR code and the one or more independent QR codes to form a merged QR code. The merged QR code may include the dependent QR code. The merged QR code may include the one or more independent QR codes. The merged QR code may include the one or more trust deficit NFTs on the dependent QR code.

The POS device may determine that the dependent QR code has a number of trust deficit NFTs that is greater than a threshold number. The POS device may reject the transaction in response to the determination that the dependent QR code has a number of trust deficit NFTs greater than the threshold number.

The POS device may generate an additional trust deficit NFT based on one or more previous transactions of a user associated with the dependent QR code. The POS device may generate an additional trust deficit NFT, wherein the additional trust deficit NFT is included in the merged QR code. The POS device may determine a location of the dependent QR code within the merged QR code based on the decrypted algorithmic code. The POS device may generate one or more trust deficit NFTs wherein the decrypted algorithmic code determines a placement of the one or more trust deficit NFTs within the merged QR code.

The POS device may, if the number of trust deficit NFTs is less than the threshold number, place the trust deficit NFTs within the merged QR code such that it allows a scan of the dependent QR code to be processed at a QR code scanning device. The POS device may, if the number of trust deficit NFTs is greater than the threshold number, place the trust deficit NFTs within the merged QR code such that it prevents a scan of the dependent QR code to be processed at a QR code scanning device.

The POS device may accept the transaction in response to a determination that the dependent QR code has lower than a threshold number of trust deficit NFTs. The POS device may allow a scan of the dependent QR code to be processed at a QR code scanning device when the number of trust deficit NFTs is four or less. The threshold number of trust deficit NFTs may be, e.g., five.

The POS device may create one or more trust NFTs for each of the one or more independent QR codes associated with one or more users approving the transaction. The POS device may add the one or more trust NFTs to the merged QR code. The POS device may determine that the dependent QR code within the merged QR code holds at least a threshold number of trust NFTs. The POS device may override the determination that the dependent QR code has a number of trust deficit NFTs that is greater than the threshold number of trust deficit NFTs. The POS device may approve the transaction in response to a determination that the dependent QR code within the merged QR code has at least a threshold number of trust NFTs.

The POS device may create one or more trust NFTs for each of the one or more independent QR codes associated with one or more users approving the transaction. The POS device may add the one or more trust NFTs to the merged QR code. The POS device may determine that the dependent QR code within the merged QR code holds more trust deficit NFTs than trust NFTs. The POS device may reject the transaction in response to a determination that the dependent QR code within the merged QR code holds more trust deficit NFTs than trust NFTs.

The following figures and associated written specifications set forth the disclosure in additional detail to the foregoing.

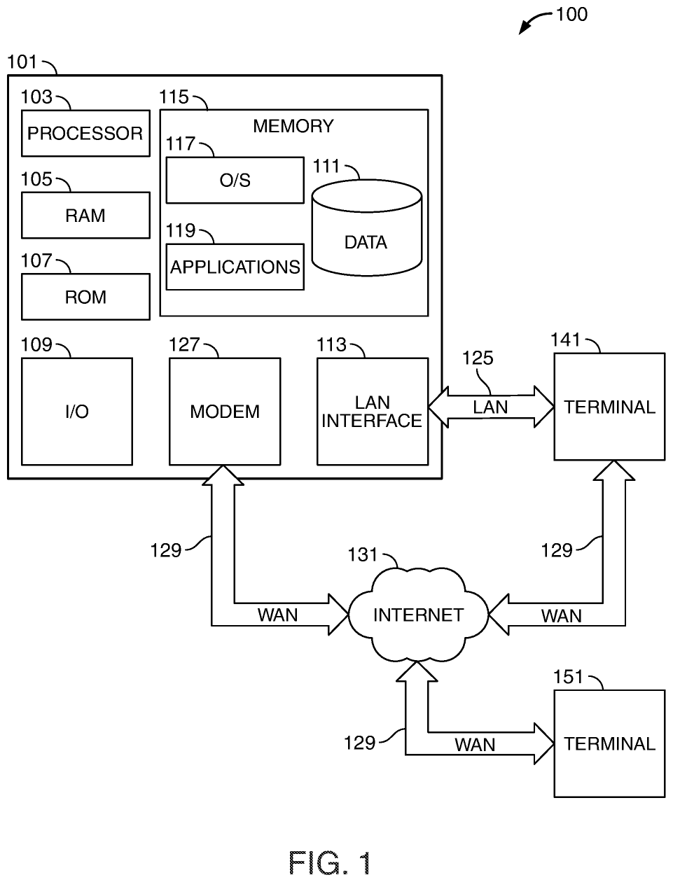

FIG. 1 shows an illustrative block diagram of system 100 that includes computer 101. Computer 101 may alternatively be referred to herein as an “engine,” “server” or a “computing device.” Computer 101 may be a workstation, desktop, laptop, tablet, smartphone, or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may have a processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. The processor 103 may also execute all software running on the computer. Other components commonly used for computers, such as EEPROM or Flash memory or any other suitable components, may also be part of the computer 101.

The memory 115 may be comprised of any suitable permanent storage technology—e.g., a hard drive. The memory 115 may store software including the operating system 117 and application program(s) 119 along with any data 111 needed for the operation of the system 100. Memory 115 may also store videos, text, and/or audio assistance files. The data stored in memory 115 may also be stored in cache memory, or any other suitable memory.

I/O module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129 but may also include other networks. When used in a LAN networking environment, computer 101 is connected to LAN 125 through LAN interface 113 or an adapter. When used in a WAN networking environment, computer 101 may include a modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (API). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks.

Application program(s) 119 may include computer executable instructions (alternatively referred to as “programs”). The computer executable instructions may be embodied in hardware or firmware (not shown). The computer 101 may execute the instructions embodied by the application program(s) 119 to perform various functions.

Application program(s) 119 may utilize the computer-executable instructions executed by a processor. Generally, programs include routines, programs, objects, components, data structures, etc., that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

Any information described above in connection with data 111, and any other suitable information, may be stored in memory 115.

The disclosure may be described in the context of computer-executable instructions, such as application(s) 119, being executed by a computer. Generally, programs include routines, programs, objects, components, data structures, etc., that perform particular tasks or implement particular data types. The disclosure may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone, or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The disclosure may be operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

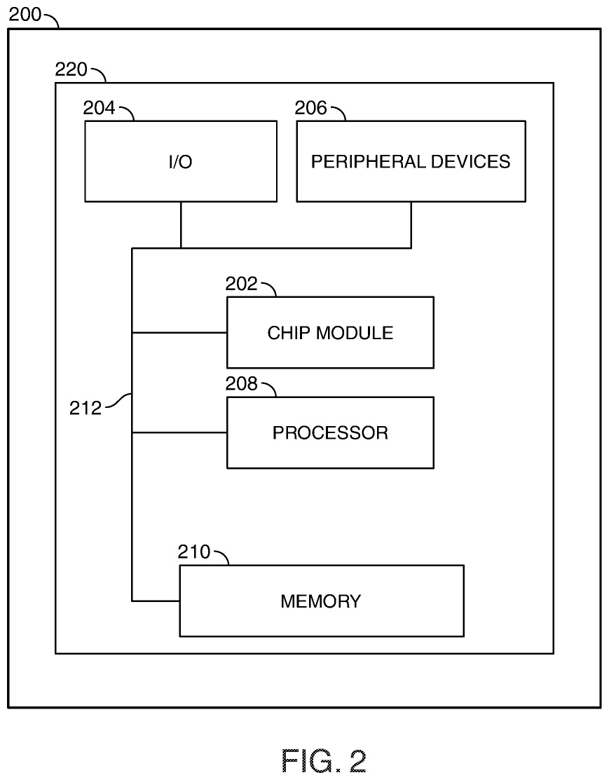

FIG. 2 shows illustrative apparatus 200 that may be configured in accordance with the principles of the disclosure. Apparatus 200 may be a computing device. Apparatus 200 may include one or more features of the apparatus shown in FIG. 2. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 119, signals, and/or any other suitable information or data structures.

Components 202, 204, 206, 208 and 210 may be coupled together by a system bus or other interconnections 212 and may be present on one or more circuit boards such as circuit board 220. In some embodiments, the components may be integrated into a single chip. The chip may be silicon-based.

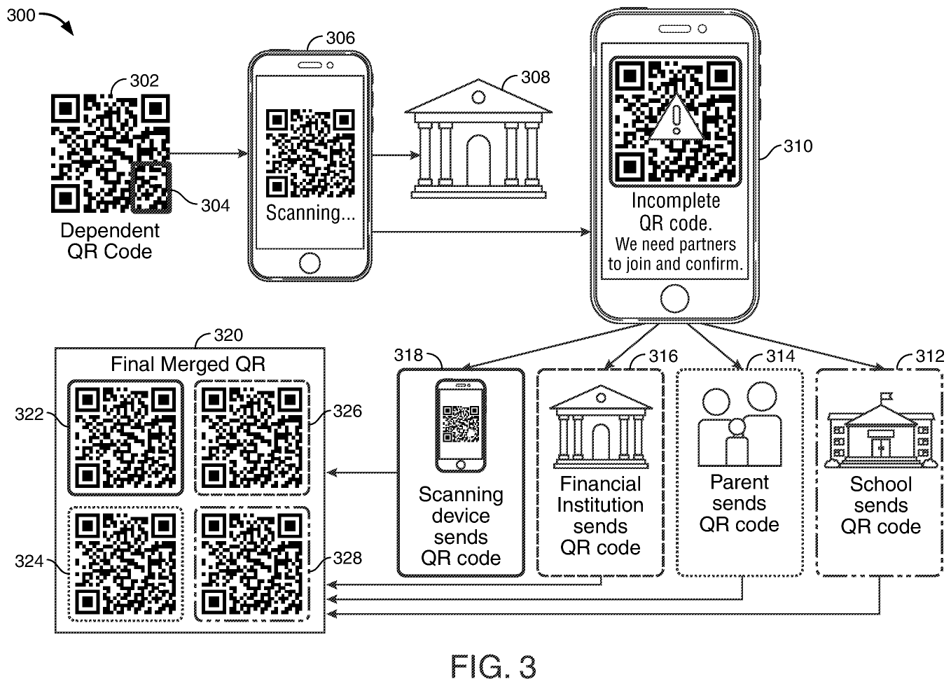

FIG. 3 shows a schematic diagram of an amalgamated QR code generation method 300 in accordance with principles of the disclosure. At 302, a dependent QR code is shown. At 304, a subsection of the dependent QR code is shown. The dependent QR code 302, as well as, e.g., dependent QR code subsection 304, may initiate a transaction request. At 306, a mobile device is shown which can be used to scan the dependent QR code generated by a QR-code generating device.

Financial institution 308 may receive information from the scanned dependent QR code 302. At 310, a mobile device is shown which can be used to alert independent QR codes regarding the transaction request from dependent QR code 302. An alert message may appear on mobile device 310, e.g., “Incomplete QR code. We need partners to join and confirm.” Here, partners are equivalent to independent QR codes that may approve and deny dependent QR code transaction requests.

Independent QR codes, e.g., school QR code 312, parent QR code 314, financial institution QR code 316, and dependent QR code, e.g., scanning device QR code 318, may be sent to the mobile device 310, and merged into a final merged QR code 320. The final merged QR code 320 may contain both dependent and independent QR codes, e.g., dependent QR code 322 and independent QR codes 324, 326, and 328.

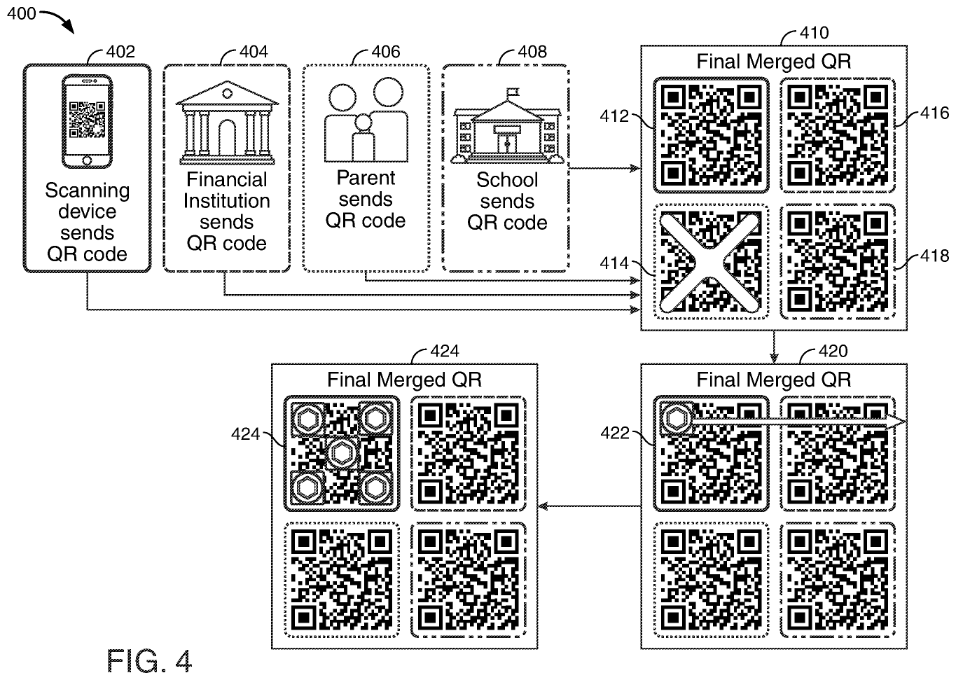

FIG. 4 shows a schematic diagram 400 of a final merged QR code 424 for improving security of dependent QR code transactions in accordance with principles of the disclosure. Dependent QR code, e.g., scanning device code 402, and independent QR codes, e.g., financial institution QR code 404, parent QR code 406, and school QR code 408 may be merged into the final merged QR code 410.

Final merged QR code 410 may contain a dependent QR code 412 and independent QR codes 414, 416, and 418. Independent QR code 414 may, for example, reject the dependent QR code 412 transaction request. Independent QR code 414 denial may be represented by an X over the independent QR code 414.

After an independent QR code denial, final merged QR code 420 contains dependent QR code 422 possessing a trust deficit NFT. The trust deficit NFT is placed on the dependent QR code 422 corresponding to a transaction request rejection from, e.g., independent QR code 414.

After, e.g., five independent QR code transaction request denials, dependent QR code 424 within final merged QR code 424 may hold five trust deficit NFTs. When a dependent QR code holds a threshold number of trust deficit NFTs, e.g., five, the dependent QR code may be deactivated, unable to transact, and prevented from being scanned.

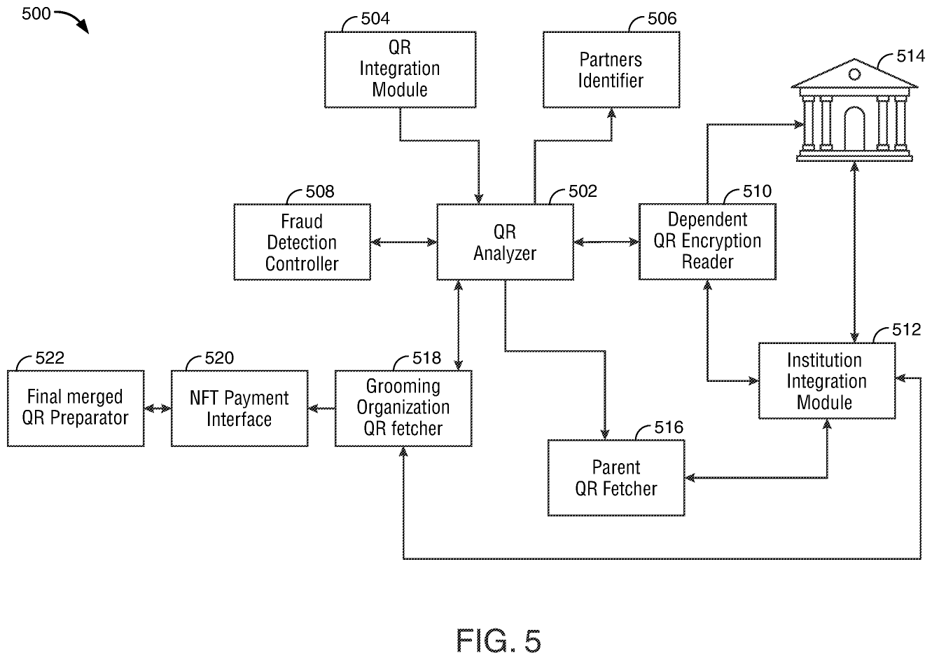

FIG. 5 shows a schematic flow diagram 500 of a dependent QR code security procedure in accordance with principles of the disclosure.

QR Integration Module 504 may integrate a dependent QR code with independent QR codes, financial institutions, and other entities. The QR Integration Module 504 may receive information from a dependent QR code via a QR code scanning device. The QR Integration Module 504 may send the dependent QR code to a QR Analyzer 502.

The QR Analyzer 502 may receive and analyze the dependent QR code. The QR Analyzer 502 may determine which partners, e.g., independent QR codes that may approve and reject dependent QR code transaction requests, must be asked to approve a transaction request. QR Analyzer 502 sends information to a Partners Identifier 506 to obtain information about the required independent QR codes for dependent QR code transaction approval.

The Partners Identifier 506 may send information back to the QR Analyzer 502. The Partners Identifier 506 may identify the independent QR codes necessary to approve a transaction for a dependent QR code. The QR Analyzer 502 may merge the dependent and independent QR codes into a merged QR code.

The QR Analyzer 502 may send information about, e.g, the dependent QR code and the independent QR codes to a Fraud Detection Controller 508. The Fraud Detection Controller 508 may detect current and past fraud reported for the dependent QR code and the independent QR codes. The Fraud Detection Controller 508 may send fraud information regarding the dependent QR code and the independent QR codes to the QR Analyzer 502.

The QR Analyzer 502 may send information about, e.g, the dependent QR code and the independent QR codes to a Dependent QR Encryption Field Reader 510. The Dependent QR Encryption Field Reader 510 may decrypt the encrypted data from the dependent and independent QR codes. The decrypted QR code information may be sent from the Dependent QR Encryption Field Reader 510 to, e.g., a financial institution 514.

Dependent QR Encryption Field Reader 510 and financial institution 514 may send information to Institution Integration Module 512. The Institution Integration Module 512 may integrate a financial institution 514 with the merged QR code. The Institution Integration Module 512 may send information back to the QR Analyzer 502 for analysis.

The Institution Integration Module 512 may send information to a Parent QR Fetcher 516. The Parent QR Fetcher 516 may fetch independent QR codes for parents and guardians of a dependent, e.g., a minor, an incapacitated individual, etc. The Parent QR Fetcher 516 may ensure that all parents and guardians of an independent QR code are consulted prior to approving or rejecting a dependent QR code.

The Parent QR Fetcher 516 may transmit information to the QR Analyzer 502 for analysis. The QR Analyzer 502 and the Institution Integration Module 512 may send information to a Grooming Organization QR Fetcher 518.

The Grooming Organization QR Fetcher 518 may fetch independent QR codes for organizations needed to groom a dependent QR code transaction request for fraud, trust deficits, or trust merits. The Grooming Organization QR Fetcher 518 may send information to the Institution Integration Module 512 for integration of grooming organization information with financial institution information. The Grooming Organization QR Fetcher 518 may send information to an NFT Payment Interface 520.

The NFT Payment Interface 520 may create trust deficit NFTs and trust NFTs and place them on dependent QR codes based on information from the Grooming Organization QR Fetcher 518. The NFT Payment Interface 520 may determine whether a dependent QR code may transact based on the number of trust deficit NFTs and trust NFTs the dependent QR code holds. The NFT Payment Interface 520 may send information to a Final Merged QR Preparator 522.

The Final Merged QR Preparator 522 may create a final merged QR code containing, e.g., dependent QR codes, independent QR codes, and trust deficit NFTs and trust NFTs over the dependent QR codes within the merged QR code. The Final Merged QR Preparator 522 may send information to the NFT Payment Interface 520 approving or rejecting dependent QR code transaction requests. The Final Merged QR Preparator 522 may allow for approvals and rejections of dependent QR code transactions based on information provided by independent QR codes, e.g., parents, guardians, financial institutions, educational institutions, and other entities.

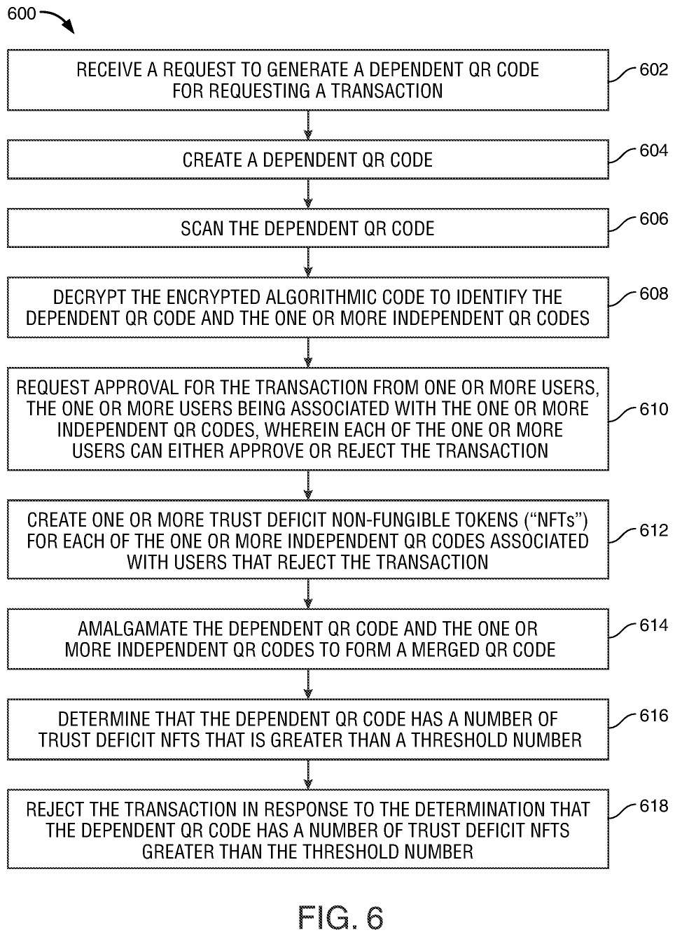

FIG. 6 shows an illustrative flow chart diagram 600 in accordance with principles of the disclosure.

The illustrative flow chart diagram 600 shows an exemplary method or system in accordance with principles of the disclosure. The illustrative flow chart diagram 600 shows a method or system that may include step 602 to receive a request to generate a dependent QR code for requesting a transaction.

The method or system may include the next step 604 to create a dependent QR code.

Step 606 of the flow chart may be to scan the dependent QR code.

Step 608 of the flow chart may be to decrypt the encrypted algorithmic code. Decrypting the encrypted algorithmic code may identify the dependent QR code and the one or more independent QR codes.

Step 610 of the flow chart may be to request approval for the transaction from one or more users. The one or more users may be associated with the one or more independent QR codes. Each of the one or more users may either approve or reject the transaction.

Step 612 of the flow chart may be to create one or more trust deficit NFTs for each of the one or more independent QR codes associated with users that reject the transaction.

Step 614 of the flow chart may be to amalgamate the dependent QR code and the one or more independent QR codes to form a merged QR code.

Step 616 of the flow chart may be to determine that the dependent QR code has a number of trust deficit NFTs that is greater than a threshold number.

Step 618 of the flow chart may be to reject the transaction in response to the determination that the dependent QR code has a number of trust deficit NFTs greater than the threshold number.

The steps of methods and systems may be performed in orders beyond the order shown and/or described herein. Embodiments may omit steps shown and/or described in connection with illustrative methods. Embodiments may include steps that are neither shown nor described in connection with illustrative methods.

Illustrative methods and systems steps may be combined. For example, an illustrative method may include steps shown in connection with another illustrative method.

Methods and systems may omit features shown and/or described in connection with illustrative methods and systems. Embodiments may include features that are neither shown nor described in connection with the illustrative methods and systems. Features of illustrative methods and systems may be combined. For example, an illustrative embodiment may include features shown in connection with another illustrative embodiment.

The drawings show illustrative features of methods and systems in accordance with the principles of the disclosure. The features are illustrated in the context of selected embodiments. It will be understood that features shown in connection with one of the embodiments may be practiced in accordance with the principles of the disclosure along with features shown in connection with another of the embodiments.

One of ordinary skill in the art will appreciate that the steps shown and described herein may be performed in other ways and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods and systems for providing an amalgamated QR-powered, NFT-scoring-based protégé money transfer technology are provided. Persons skilled in the art will appreciate that the present invention can be practiced by other than the described embodiments, which are presented for purposes of illustration rather than of limitation, and that the present invention is limited only by the claims that follow.

What is claimed is:

1. A method for providing a quick response (“QR”) code having increased security authentication parameters, the method comprising:
receiving a request to generate a dependent QR code for requesting a transaction;
creating a dependent QR code including:
an encrypted algorithmic code;
a request for the transaction; and
one or more independent QR codes;
wherein the dependent QR code is unable to be used to execute the transaction without obtaining approval from the one or more independent QR codes associated with the dependent QR code;
scanning the dependent QR code;
decrypting the encrypted algorithmic code to identify:
the dependent QR code; and
the one or more independent QR codes;
requesting approval for the transaction from one or more users, the one or more users being associated with the one or more independent QR codes, wherein each of the one or more users can either approve or reject the transaction;
creating one or more trust deficit non-fungible tokens (“NFTs”) for each of the one or more independent QR codes associated with users that reject the transaction;
amalgamating the dependent QR code and the one or more independent QR codes to form a merged QR code, the merged QR code comprising:
the dependent QR code;
the one or more independent QR codes; and
the one or more trust deficit NFTs;
determining that the dependent QR code has a number of trust deficit NFTs that is greater than a threshold number; and
rejecting the transaction in response to the determination that the dependent QR code has a number of trust deficit NFTs greater than the threshold number.

2. The method of claim 1 further comprising generating an additional trust deficit NFT based on one or more previous transactions of a user associated with the dependent QR code.

3. The method of claim 2 wherein the additional trust deficit NFT is included in the merged QR code.

4. The method of claim 1 wherein a location of the dependent QR code within the merged QR code is determined based on the decrypted algorithmic code.

5. The method of claim 1 wherein the decrypted algorithmic code determines a placement of the one or more trust deficit NFTs within the merged QR code.

6. The method of claim 5 further comprising:
placing the trust deficit NFTs within the merged QR code such that it allows a scan of the dependent QR code to be processed at a QR code scanning device when the number of trust deficit NFTs is less than the threshold number; and
placing the trust deficit NFTs within the merged QR code such that it prevents a scan of the dependent QR code to be processed at a QR code scanning device when the number of trust deficit NFTs is greater than the threshold number.

7. The method of claim 1 further comprising accepting the transaction in response to a determination that the dependent QR code has lower than a threshold number of trust deficit NFTs.

8. The method of claim 7 further comprising allowing a scan of the dependent QR code to be processed at a QR code scanning device when the number of trust deficit NFTs is four or less, wherein the threshold number is five.

9. The method of claim 1 further comprising:
creating one or more trust NFTs for each of the one or more independent QR codes associated with one or more users approving the transaction;
adding the one or more trust NFTs to the merged QR code;
determining that the dependent QR code within the merged QR code holds at least a threshold number of trust NFTs;
overriding the determination that the dependent QR code has a number of trust deficit NFTs that is greater than the threshold number of trust deficit NFTs; and
approving the transaction in response to a determination that the dependent QR code within the merged QR code has at least a threshold number of trust NFTs.

10. The method of claim 1 further comprising:
creating one or more trust NFTs for each of the one or more independent QR codes associated with one or more users approving the transaction;
adding the one or more trust NFTs to the merged QR code;
determining that the dependent QR code within the merged QR code holds more trust deficit NFTs than trust NFTs; and
rejecting the transaction in response to a determination that the dependent QR code within the merged QR code holds more trust deficit NFTs than trust NFTs.

11. A system for providing a quick response (“QR”) code having increased security authentication parameters, the system comprising:
a dependent user device;
one or more independent user devices; and
a point of sale (“POS”) device;
the dependent user device configured to:
receive a request to generate a dependent QR code for requesting a transaction; and
create a dependent QR code including:
an encrypted algorithmic code; and
a request for the transaction;
the one or more independent user devices configured to:
receive the request for the transaction; and
create one or more independent QR codes, the dependent QR code being unable to transact without obtaining approval from one or more users associated with the one or more independent QR codes associated with the dependent QR code;
the POS device configured to:
scan the dependent QR code;
decrypt the encrypted algorithm code to identify:
the dependent QR code; and
the one or more independent QR codes;
request approval for the transaction from the one or more users associated with the one or more independent QR codes, wherein each of the one or more users associated with the one or more independent QR codes can either approve or reject the transaction;
create one or more trust deficit non-fungible tokens (“NFTs”) for each of the one or more independent QR codes associated with one or more users rejecting the transaction;
amalgamate the dependent QR code and the one or more independent QR codes to form a merged QR code, the merged QR code comprising:
the dependent QR code;
the one or more independent QR codes; and
the one or more trust deficit NFTs on the dependent QR code;
determine that the dependent QR code has a number of trust deficit NFTs that is greater than a threshold number; and
reject the transaction in response to a determination that the dependent QR code has a number of trust deficit NFTs greater than the threshold number.

12. The POS device of claim 11 further configured to generate an additional trust deficit NFT based on one or more previous transactions of a user associated with the dependent QR code.

13. The POS device of claim 12, wherein the additional trust deficit NFT is included in the merged QR code.

14. The POS device of claim 11, wherein a location of the dependent QR code within the merged QR code is determined based on the decrypted algorithmic code.

15. The POS device of claim 11, wherein the decrypted algorithmic code determines a placement of the one or more trust deficit NFTs within the merged QR code.

16. The POS device of claim 15 further configured to, wherein:
if the number of trust deficit NFTs is less than the threshold number, place the trust deficit NFTs within the merged QR code such that it allows a scan of the dependent QR code to be processed at a QR code scanning device; and
if the number of trust deficit NFTs is greater than the threshold number, place the trust deficit NFTs within the merged QR code such that it prevents a scan of the dependent QR code to be processed at a QR code scanning device.

17. The POS device of claim 11 further configured to accept the transaction in response to a determination that the dependent QR code has lower than a threshold number of trust deficit NFTs.

18. The POS device of claim 17 further configured to allow a scan of the dependent QR code to be processed at a QR code scanning device when the number of trust deficit NFTs is four or less, wherein the threshold number of trust deficit NFTs is five.

19. The POS device of claim 11 further configured to:
create one or more trust NFTs for each of the one or more independent QR codes associated with one or more users approving the transaction;
add the one or more trust NFTs to the merged QR code;
determine that the dependent QR code within the merged QR code holds at least a threshold number of trust NFTs;
override a determination that the dependent QR code has a number of trust deficit NFTs that is greater than the threshold number of trust deficit NFTs; and
approve the transaction in response to a determination that the dependent QR code within the merged QR code has at least a threshold number of trust NFTs.

20. The POS device of claim 11 further configured to:
create one or more trust NFTs for each of the one or more independent QR codes associated with one or more users approving the transaction;
add the one or more trust NFTs to the merged QR code;
determine that the dependent QR code within the merged QR code holds more trust deficit NFTs than trust NFTs; and
reject the transaction in response to a determination that the dependent QR code within the merged QR code holds more trust deficit NFTs than trust NFTs.
